(19) United States
(12) Patent Application Publication
(10) Pub. No.: US 2002/0007423 A1
(43) Pub. Date: Jan. 17, 2002

(54) Message processing system and method

(76) Inventor: Hidekazu Arao, Kawasaki (JP)

Correspondence Address: STAAS & HALSEY, 700 Eleventh Street, N.W., Suite 500, Washington, DC, 20001, US

(21) Appl. No.: 09/732,874

(22) Filed: Dec. 11, 2000

(30) Foreign Application Priority Data
May 31, 2000 (JP) 2000-162163

(51) Int. Cl. G06F 9/46

(52) U.S. Cl. 709/318

(57) ABSTRACT

The object of the present invention is to provide technology for setting and modifying the content of processing for messages according to the time a message occurs, etc. The message processing system of the present invention analyzes a received message, and judges whether a predetermined condition including a requirement relating to a time when the received message occurs is fulfilled. If it is judged that the received message fulfilled the predetermined condition, the message processing system performs a process corresponding to the fulfilled predetermined condition. Therefore, different processing can be executed according to the time range in which a message occurs. For example, when a message with a message number “S6532” occurs between 8:00 and 12:00, it is displayed on a monitor of a terminal installed at an office, and when a message occurs between 12:00 and 18:00, it is displayed on a monitor of a terminal outside the office.

### TECHNICAL FIELD OF THE INVENTION

The present invention relates to technology to process messages including messages displayed on a display device, messages exchanged among programs, and communication messages such as e-mail, more particularly to technology for executing the processing which corresponds to a predetermined condition, for messages which fulfill the predetermined condition.

### BACKGROUND OF THE INVENTION

A lot of conventional computer systems display, on a predetermined system monitoring console display, message contents including predetermined message numbers and/or message text at a time when a certain event occurs if the event occurs during the execution of program such as an operating system and/or application programs.

However, for example, Japanese Patent Laid-open Publication No. 8-221240 discloses a centralized message monitoring system comprises: a console definition file provided at each terminal for setting a terminal ID to which a message is sent, means for referring to the console definition file and then sending a message to a terminal of the terminal ID set in the definition file when an event to be displayed on the console of the terminal occurs, and means for enabling the terminal of the terminal ID to receive the sent message and display the message on the console.

Japanese Patent Laid-open Publication No. 6-103199 also discloses the following technology. Namely, a recording unit of a transfer server records a message sent by a login to a user computer via a communication line, and an analyzing unit of the transfer server analyzes the message based on the user information table of the table unit. A transfer destination is then selected by the user entering the name of the server to be forwarded to, and the transfer unit then forwards the message to one or a plurality of computers. It is also disclosed that the message is forwarded dynamically in accordance with the user movement by analyzing the status of the computers' connection to the network.

For the communication of messages between programs, the communication of the messages with predetermined contents is carried out at the time the message occurs. Similarly, when a program is activated by a message, a predetermined program is activated when the message occurs.

As for e-mail, the following technology already exists. For example, in Japanese Patent Laid-open Publication No. 10-207795, it is disclosed that arrival messages are filtered by individual transfer processing means, new messages are made based on the arrival if conditions set by a user in advance in transfer condition storage means are fulfilled, and the mail corresponding to the new message is transferred to a mail address designated in advance by the user. This publication also discloses that a user can send a transfer condition setting request mail disclosing what transfer condition the user wishes to set for an e-mail of e-mails that have arrived in an e-mail box for the user and which address the user wishes to transfer the mail satisfying the set condition, to an address allocated to a transfer condition setting program.

In Japanese Patent Laid-open Publication No. 10-191409, it is disclosed that a message transfer system for forwarding messages from user terminals connected via a communication network to other terminals. In this technology, a user terminal can designate the time to have a mail server forward a message to another user's terminal, and the message is converted into the appropriate code by the mail server so as to be compatible with service providers and/or other terminals, then is sent at the designated time.

In addition, Nifty Co. Ltd., provides a service where a user can designate a sending date within the body of an e-mail.

### SUMMARY OF THE INVENTION

However, none of the related technologies mentioned above considers the time the message occurs. Therefore, the object of the present invention is to provide technology for setting and modifying the content of processing for messages according to the time a message occurs, etc.

The message processing system of the first aspect of the present invention comprises judging means for analyzing a received message, and for judging whether a predetermined condition including a requirement relating to a time when the received message occurs is fulfilled; and means for performing a process corresponding to the fulfilled predetermined condition if the judging means judged that the received message fulfilled the predetermined condition.

If a message is judged to fulfill the predetermined condition including a requirement for the time the message occurs by the judging means, a process corresponding to the predetermined condition may be performed. Therefore, different processing can be executed according to the time range in which a message occurs. For example, when a message with a message number “S6532” occurs between 8:00 and 12:00, it is displayed on a monitor of a terminal installed at an office, and when a message occurs between 12:00 and 18:00, it is displayed on a monitor of a terminal outside the office.

The above-described process corresponding to the predetermined condition may be at least one of modification and/or setting of contents of the received message, modification and/or setting of display destination of the received message, modification and/or setting of transmission destination of the received message, modification and/or setting of recording destination of the received message, and execution of a program in correspondence with the received message. The process can be a combination of two or more of these processings.

If the process corresponding to the predetermined condition is for setting and/or modification of the message transfer or display destination, priorities may be set to each of a plurality of transfer and/or display destinations, so that a message notification destination (transfer destination or display destination) can be modified according to the priority. In the case of message transfer failures, the message can be automatically forwarded to other destinations more capable of receiving the message successfully.

It is also possible to provide another configuration where a process corresponding to the predetermined condition is performed at a predetermined time, not immediately after the message occurs. For example, a setting for forwarding an e-mail that was sent to an address A between 8:00 and 12:00 to another address B at 12:00 is convenient in the case of the user movement between several offices.

In a first aspect of the present invention, it is also possible to provide a configuration having a storage device for storing the predetermined condition and a processing content corresponding to the predetermined condition; and setting means for setting the predetermined condition and a processing content corresponding to the predetermined condition into the storage device.

The setting means can be composed so as to receive a control message including a predetermined condition and processing content corresponding to the predetermined condition, and to set the predetermined condition and processing content corresponding to the predetermined condition in the storage device.

The setting means described above can be composed to receive an e-mail including a header comprising the predetermined condition and processing content corresponding to the predetermined condition and to set the predetermined condition and the processing content corresponding to the predetermined condition in the storage device. Further, the judging means may determine whether or not a message subsequent to the e-mail fulfills the predetermined condition set by the setting means in response to receipt of the e-mail.

It is also possible to adopt a configuration where the setting means receives an e-mail including the predetermined condition, processing content corresponding to the predetermined condition, and a mail body, and sets, into the storage device, the predetermined condition and the processing content corresponding to the predetermined condition, and the judging means determines whether or not a message subsequent to the e-mail fulfills the prescribed condition set by the setting means in response to receipt of the e-mail. Therefore, users can set a transfer condition etc. while sending e-mail, moreover, they are not required to set a condition for each e-mail every time when sending e-mail.

A message processing method of a second aspect of the present invention comprises the steps of: analyzing a received message, and judging whether a predetermined condition including a requirement relating to a time when the received message occurred is fulfilled; and performing a process corresponding to the fulfilled predetermined condition if it is judged in the step of analyzing and judging that the received message fulfilled the predetermined condition.

Variation of the first aspect of the present invention can also be applied to the second aspect of the present invention. It is also possible to make a program for executing the message processing method of the second aspect of the present invention on a computer, and the program can be stored in storage media or storage devices such as floppy disk, CD-ROM, magnet optical disk, semiconductor memory, or a hard disk, etc. The intermediate results of the processing are held in the memory, temporarily.

### BRIEF DESCRIPTION OF THE DRAWINGS

FIG. 1 is a block diagram showing a system for a preferred embodiment of the present invention;

FIG. 2 shows an example of a format for a message;

FIG. 3 shows an example of a format for message converting information in the preferred embodiment of the present invention;

FIG. 4 is a table showing a specific example of message converting information;

FIG. 5 is a flowchart (first of three) showing a process for converting a message in the message converting device;

FIG. 6 is a flowchart (second of three) showing the process of converting a message in the message converting device;

FIG. 7 is a flowchart (third of three) showing the process of converting a message in the message converting device;

FIG. 8 is a flowchart showing a process carried out by the message converting device at an operation time if the operation time is designated;

FIG. 9A is a specific example (first of six) of message converting information;

FIG. 9B is a processing diagram using the message converting information shown in FIG. 9A;

FIG. 10A is a specific example (second of six) of message converting information;

FIG. 10B is a processing diagram using the message converting information shown in FIG. 10A;

FIG. 11A is a specific example (third of six) of message converting information;

FIG. 11B is a processing diagram using the message converting information shown in FIG. 11A;

FIG. 12A is a specific example (fourth of six) of message converting information;

FIG. 12B is a processing diagram using the message converting information shown in FIG. 12A;

FIG. 13A is a specific example (fifth of six) of message converting information;

FIG. 13B is a processing diagram using the message converting information shown in FIG. 13A;

FIG. 14A is a specific example (sixth of six) of message converting information;

FIG. 14B is a processing diagram using the message converting information shown in FIG. 9A;

FIG. 15 is an example of a format where the header part of the e-mail includes message converting information;

FIG. 16 shows a specific example (first of two) of FIG. 15;

FIG. 17 shows a specific example (second of two) of FIG. 15;

FIG. 18A shows a diagram of an e-mail that includes only control message in the header;

FIG. 18B shows a diagram of an e-mail which includes the control message in the header and the body; and

FIG. 19 is a diagram if an e-mail including message converting information is processed.

### DETAIL DESCRIPTION OF THE PREFERRED EMBODIMENTS

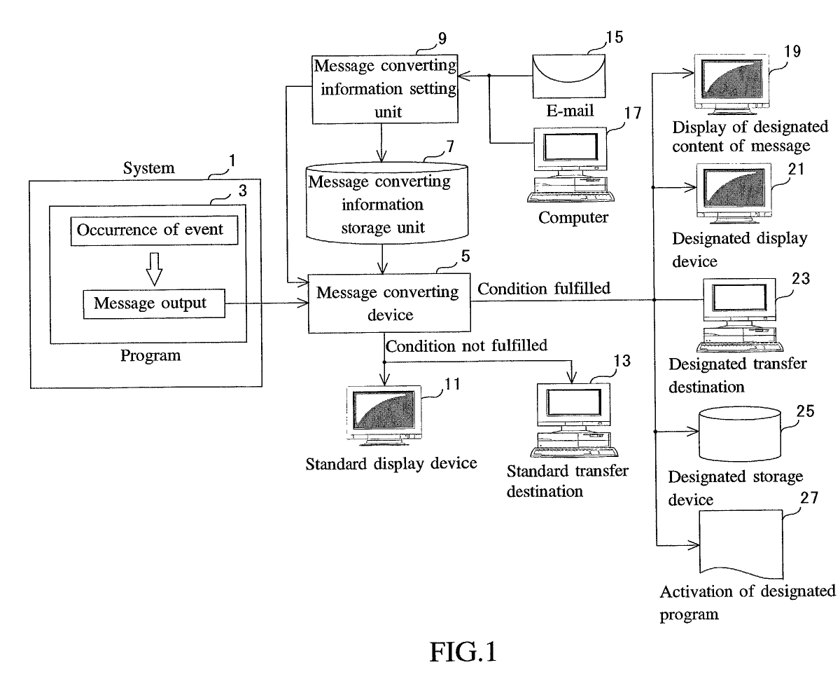

The entire system of the preferred embodiment of the present invention is described in FIG. 1. A message converting device 5 of the present invention is coupled to a system 1. The message converting device 5 is coupled to a message converting information storage unit 7 which stores message converting information including the conditions concerning the messages and the contents of the processing corresponding to the conditions, and which performs the processing referring to the message converting information. The message converting information storage unit 7 is coupled to a message converting information setting unit 9 for setting the message converting information. The message converting device 5 is coupled to various display devices (also called as consoles) 11, 19, and 21, and to computers (including various servers) 13 and 23, and to a storage device 25, etc.

The system 1 executes a program 3. When a certain event occurs in the program 3, a message is output. This message is first sent to the message converting device 5. The message converting device 5 refers to the message converting information stored in the message converting information storage unit 7, and judges if the message fulfills any condition included in the message converting information. If the message doesn't fulfill any condition included in the message converting information, the message converting device 5 sends the message to a standard display device 11, or a computer 13 designated as the standard transfer destination, etc.

On the other hand, if the message fulfills to any of the conditions included in the message converting information, the message converting device 5 executes the process corresponding to the fulfilled condition. If modification of the content of the message is designated, the message content is modified according to the designated content and is displayed on the standard display device. If the display device is designated, the message content is displayed on the designated display device. If the transfer destination of the message is designated, the message content is transferred to the designated computer. If the storage device to record the message is designated, the message content is stored in the file in the designated storage device 25. If the program is designated to be activated, the designated program will be activated at a predetermined computer. A processing composed of combination of these functions can also be executed.

The message converting information setting unit 9 acquires message converting information from a message including an e-mail 15 or from computer 17, etc., and outputs the message converting information to the message converting information storage unit 7. For example, before shutting off the computer 17, the program in the computer 17 may output the message converting information in the predetermined form to the message converting information setting unit 9. Additionally, by executing the prescribed operation at computer 17, the program may send the message converting information to the message setting unit 9. The computer 17 may be a personal computer and a portable terminal including a cellular phone, or others.

As described below, if the message converting information is to be output to the message converting information setting unit 9 as, for example, e-mail messages, the new message converting information is applied to e-mail messages occurring thereafter. Therefore, if the message converting information is output to the message converting information setting unit 9 using the e-mail 15, the part including the message converting information of the e-mail 15 (hereafter referred to as a control message) is utilized in the message converting information setting unit 9, and other parts of the e-mail 15 are processed at the message converting device 5 as well as other messages. The message converting information setting unit 9 can be installed in the message converting device 5.

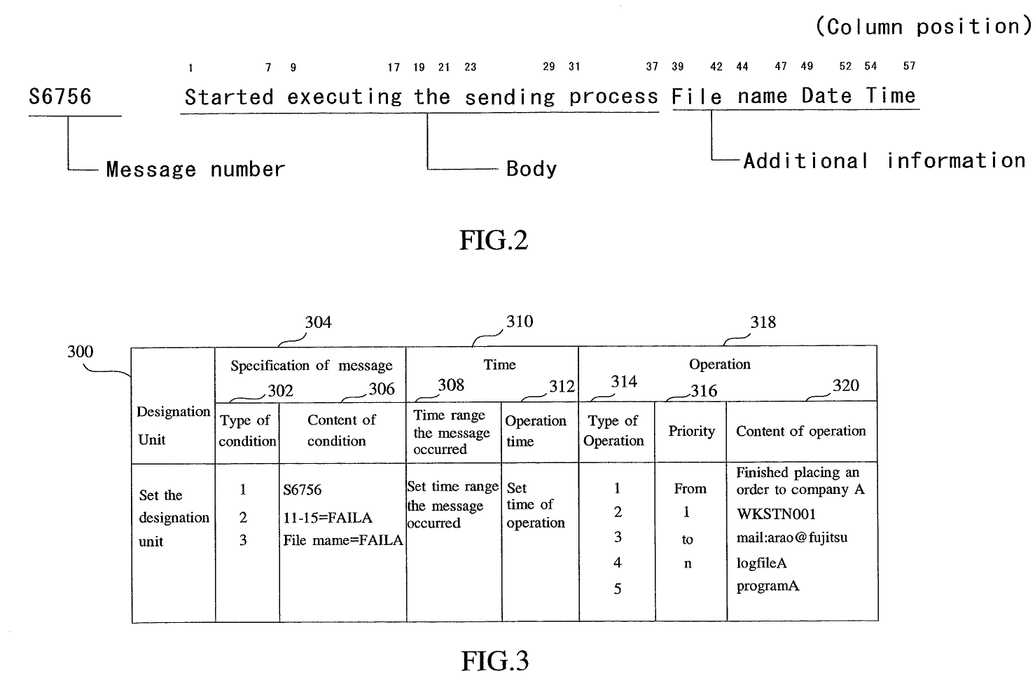

FIG. 2 shows an example of a message. In the message “S6756 Started executing the sending process File name Date Time”, “S6756” describes the message number. The count of the column position is started from the letter displayed after the message number. In this example, the text of the message, “Started executing the sending process” is displayed in columns 1 to 47. The file name related to the message is displayed in the columns 39 to 47 in this example. The date and time the message occurs are displayed in column 49 to 57. The date and time can be described as year, month, day, hour, minutes, seconds, and also can be described in a format only showing hours and minutes.

FIG. 3 shows the message converting information in table format. The designation unit 300 divides sets composed of the condition for the message and the processing content corresponding to the condition into segments. If the conditions for the messages and the contents of the processing corresponding to the conditions are not defined in the table format but in an enumerative format, the designation unit is located at the part between the starting tag “msgstart” and ending tag “msgend”.

The column 304 “Specification of message” is a segment for the definition of a part of the conditions for the messages. If “1” is defined in the column 302 “Type of condition” included in the column 304 “Specification of message”, the condition to designate the number of the message is defined in the column 306 “Content of condition”. For example, if “1” is defined in “Type of condition”, the message number, such as “S6756”, is defined in the column 306 “Content of condition”. If “2” is defined in “Type of condition”, the condition to designate the content of the message, especially the condition of the character strings included in the designated columns is defined in the column 306 “Content of condition”. For example, if “2” is defined in “Type of condition”, “11-15=FAILA” is defined in the column 306 “Content of condition”. “11-15=FAILA” means the condition that the character strings FAILA is included in the columns from 11 to 15.

If “3” is defined in “Type of condition”, the condition to designate the content of the message, especially the name and the content of the label, is defined in the column 306 “Content of condition”. For example, when “Type of condition” is “3”, “File name=FAILA” is defined in the column 306 “Content of condition”. This means that the name of the label is “File name”, and the content of the label is “FAILA”.

If “Type of condition” and “Content of condition” are not defined in the table format but in an enumerative manner, the conditions may be defined by setting a “ck” tag in front of each item of “Type of condition” between the starting tag and the ending tag, for example. In addition, the conditions may be defined by setting a “contc” tag for each item of “Content of condition” between the starting tag and the ending tag, for example.

The column 310 “Time” includes the column 308 “Time range the message occurred” which defines the condition for the message concerning the time range the message occurred, and the column 312 “Operation time” which defines the operation time as one of the processing contents which corresponds to the conditions. To define in the column 308 “Time range the message occurred”, for example, “08:00-12:00” is input. If all the time range is designated as a condition, no designation is input. In the column 312 “Operation time”, the time to start the operation prescribed in the column 318 “Operation” is defined. To start the operation prescribed in the column 318 “Operation” immediately, no designation is input. As to the time, for example, a day of the week, etc. can also be designated. To define conditions for “Time range the message occurred” and “Operation time” not in a table format but in an enumerative manner, the condition can be defined by setting a “time1” tag in front of each item of “Time range the message occurred” between the starting tag and the ending tag, for example. The condition can be defined by setting a “time2” tag in front of each item of “Operation time” between the starting tag and the ending tag as well.

The column 318 “Operation” is a segment for the definition of processing contents corresponding to the conditions prescribed for the message. If “1” is defined in the column 314 “Type of operation” included in the column 318 “Operation”, the designated or modified message content is defined in the column 320 “Content of operation”. If “2” is defined in the column 314 “Type of operation” included in the column 318 “Operation”, the display device designated and/or modified to display the message is displayed as defined in the column 320 “Content of operation”. If “3” is defined in the column 314 “Type of operation”, the designated and/or modified transfer destination for the message is defined in column 320 “Content of operation”. If “4” is defined in the column 314 “Type of operation”, the designated and/or modified storage device to record the message is defined in column 320 “Content of operation”. If “5” is defined in the column 314 “Type of operation”, the designated and/or modified name of the program to be activated is defined in the column 320 “Content of operation”.

If a plurality of types of operation are designated in column 314 “Type of operation”, the priority of each type of operation designated can be defined in the column 316 “Priority” included in the column 318 “Operation”. If “2” or “3” is defined in the column 314 “Type of operation”, there is a possibility of operation failure designated in the column 320 “Content of operation” caused by the computer at the transfer destination being out of operation, or the display device being out of operation. Therefore, the designation of a plurality of transfer destinations and/or display devices may be performed to deliver the message to users as efficiently as possible.

The column 320 “Content of operation” is a segment for defining the contents of the operation corresponding to the conditions prescribed for the message. If “1” is designated in “Type of operation”, the modified content of the message is defined as, for example, “Finished placing order to A company”. If “2” is designated in “Type of operation”, the display device is defined, for example, as “WKSTAN001”. If “3” is designated in “Type of operation”, the name of the transfer tool and the transfer destination is defined, for example, as “mail:arao@fujitsu”. Here, as to definition of the name of the forwarding tool, whether to send by e-mail described in the above example or File Transfer Protocol (FTP) etc. is designated. If“4” is designated in “Type of operation”, the file name in the storage device is defined, for example, as “logfileA”. If “5” is defined in “Type of operation”, the program to be activated is defined, for example, as “programA”,

To define the conditions for “Type of operation” in an enumerative manner, the conditions can be defined by setting a “ok” tag in front of each number of “Type of operation” between the starting tag and the ending tag, for example. To define the conditions for “Priority” in an enumerative manner, priority can be defined by setting a “prio” tag in front of each number for “Priority” between the starting tag and the ending tag, for example. To define the conditions for “Content of operation” in an enumerative manner, the conditions can be defined by setting a “conto” tag in front of each item of “Content of operation” between the starting tag and the ending tag, for example.

By way of precaution, the following is a description of an example format to define the conditions for the message and the processing content corresponding to the condition in an enumerative manner.

TABLE 1

<cmsgstart> {The start of the entire message converting information}
<msgstart> {The start of one condition and the processing content}
<ck> {The designation of the type of the condition}
<contc> {The designation of the content of the condition}
<time1> {The designation of the time range the message occurred}
<time2> {The designation of the operation time}
<ok> {The designation of the type of the operation}
<prio> {The designation of the priority}
<conto> {The designation of the content of the operation}
<msgend> {The end of one condition and the processing content}
{The continuous designation of the conditions and the processing
contents}
<cmgstop> {The end of the entire message converting information}

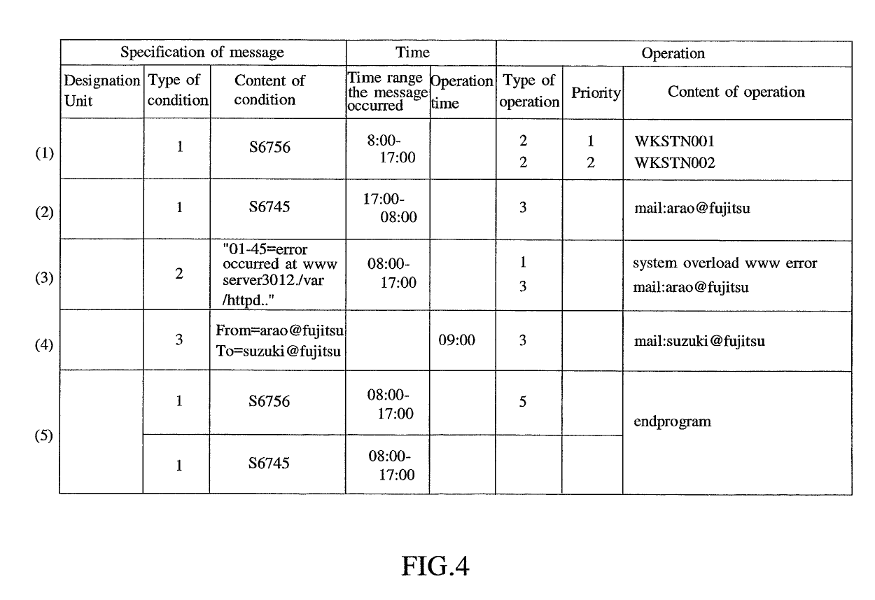

FIG. 4 shows a more specific example of FIG.3. In the designation unit (1) in FIG.4, “1” is designated for “Type of Condition”, which means that the condition is defined by the message number, and message number “S6756” is designated for “Content of condition”, “08:00-17:00” is designated for “Time range the message occurred.” “Operation time” is not designated. Two operations are designated for “Type of operation”, both are designated as “2” that means the designation of the display device. “Priority” is designated for those “Type of operation”, 1st for the operation to display the message at “WKSTN001” as for “Content of operation”, 2nd for the operation to display the message at “WKSTN002” as for “Content of operation”.

Therefore, if the message with the message number “S6756” occurs during 08:00-17:00, the message is displayed on the display device named “WKSTN00.” If the operation to display at the WKSTN001 failures, the message is displayed at WKSTN002.

In the designation unit (2) in FIG. 4, “1” is designated for “Type of Condition”, which means that the condition is defined by the message number, and message number “S6745” is designated as “Content of condition”, “17:00-8:00” is designated for “Time range the message occurred.” “Operation time” is not defined. “3” is designated for “Type of operation”, which means the designation of the transfer destination. “Priority” is not defined because single operation is set in “Type of operation”. “Mail” is designated as a transfer tool in “Content of operation”, and the transfer destination is “arao@fujitsu”.

Therefore, if the message with the message number “S6745” occurs during 17:00-08:00, the message is transferred to the address “arao@fujitsu” by e-mail.

In the designation unit (3) in FIG. 4, “2” is designated for “Type of Condition”, which means that the conditions for the position of the character and the character string are designated, and “01-45=error occurred at www server 3012./var/httpd..”, is designated for “Content of condition”. “Operation time” is not defined. Two operations are designated for “Type of operation”, one is “1” that means the modification of the message content, and another is “3” that means the designation of the message transfer destination. The priority of both operations is set “1”, in this case, the message with modified contents is sent to the designated transfer destination. “Content of operation” corresponding to the condition “1” in “Type of operation” is “system overload WWW error”,. “Content of operation” corresponding to the condition “3” in “Type of operation” is “mail:arao@fujitsu”,

Therefore, if the message with the input “error occurred at www server 3012./var/httpd..”, in the column from 1 to 45 occurs during 08:00-17:00, the message content is modified to “system overload WWW error” and is transferred to the address “arao@fujitsu” by e-mail.

In the designation unit (4) in FIG. 4, “3” is designated for “Type of Condition”, which means that the condition concerning the label in the message is designated, and “From=arao@fujitsu” and “To=suzuki@fujitsu” are designated in “Content of condition”. “Operation time” is not designated. Therefore, the message that fulfills the prescribed condition is always processed according to the items designated in “Content of operation”. On the other hand, “09:00” is defined for “Operation time”, “3” is designated in “Type of operation” that means the transfer destination is designated, and the transfer destination is “mail:arao@fujitsu.”

Therefore, if the message is a message with “arao@fujitsu” as the sender (From), and “suzuki@fujitsu” as the receiver (To), the message is transferred to “suzuki@fujitsu” at 09:00every morning in regardless of the time the message occurred.

In the designation unit (5) in FIG. 4, “1” is designated for 2 items in “Type of Condition”, which means that the condition is designated by the message number, and message number “S6745” is designated for the first item of “Content of condition”, and “S6745” for the second item of “Content of condition”. For the first item in “Content of condition”, “08:00-17:00” is defined in “Time range the message occurred”. For the second item in “Content of condition”, “08:00-17:00”, is defined in “Time range the message occurred” as well. “Operation time” is not designated. “5” is designated in the “Type of operation”, which means the designation of the program to be activated, and “endprogram” is designated to be activated.

Therefore, if the message with the message number “S6756” occurs during 08:00-17:00, and the message with the message number “S67456” occurs during 08:00-17:00as well, “endprogram” will be activated.

The following is the description of how to enumerate the designation unit (1) in FIG. 4 as shown like in Table.1.

TABLE 2

<cmsgstart>
<msgstart>
<ck>1
<contc>S6756
<time1>08:00-17:00
<time2>
<ok>2
<prio>1
<conto>WKSTN001
<ok>2
<prio>2
<conto>WKSTN002
<msgend>
<cmsgstop>

The following is the description of how to enumerate the designation unit (5) in FIG. 4 as shown like in Table.1

TABLE 3

<cmsgstart>
<msgstart>
<ok>1
<contc>S6756
<time1>08:00-17:00
<time2>
<ck>1
<contc>S6745
<time1>08:00-17:00
<time2>
<ok>5
<prio>
<contro>endprogram
<msgend>
<cmsgstop>

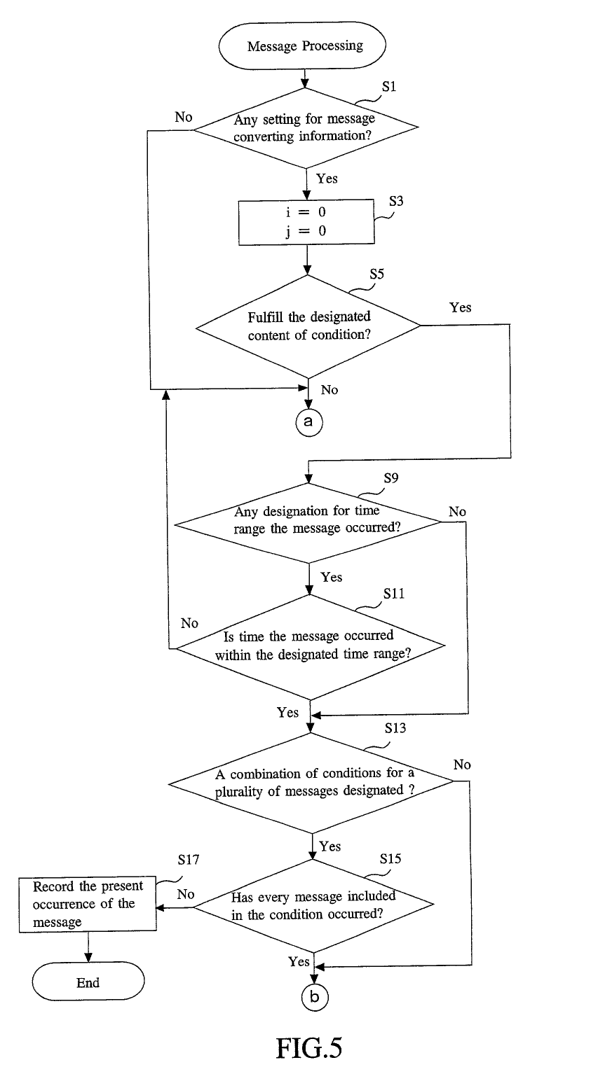

Next, the operation of the message converting device 5 is described referring to FIG. 5-8. Before processing the operation shown in FIG. 5-8, suppose that the standard message content is stored in variable A, the standard display device in variable B[0], the standard transfer destination in variable C[0], the standard storage device in variable D[0], and the standard program to be activated is variable E[0]. If the standard display device doesn't actually exist, no data is stored in B[0]. If the standard transfer destination doesn't actually exist, no data is stored in C[0] either. If a standard storage device doesn't actually exist, no data is stored in D[0]. Further, if a standard program to be activated doesn't exist, no data is stored in E[0].

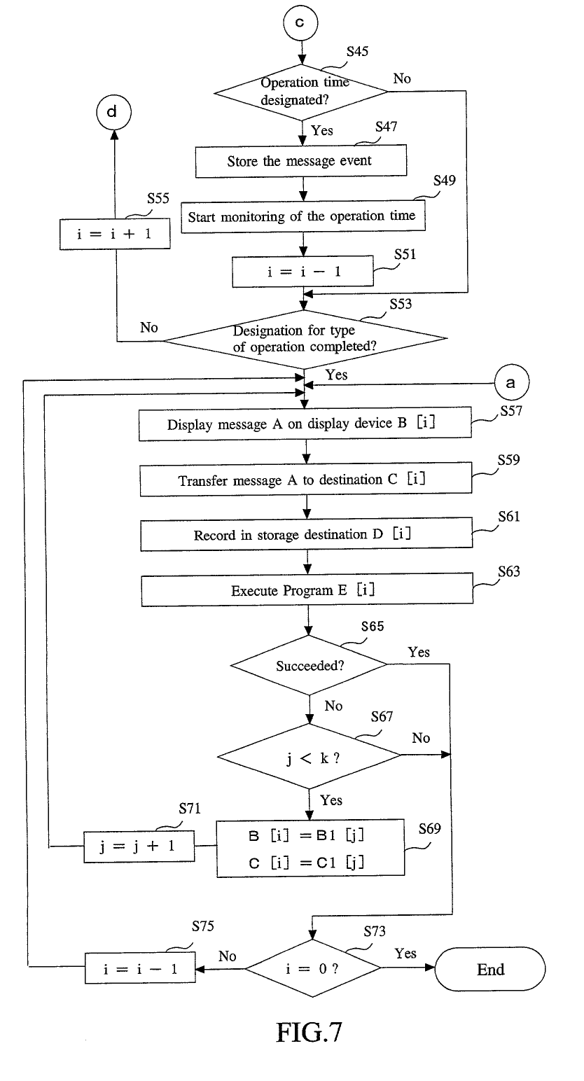

If the message converting device 5 receives a message that has occurred, the message converting device 5 judges if there are any settings for the message converting information in the message converting information storage unit 7 (step S1). If there is no message converting information, the process is shifted from terminal a to the step S57 in FIG. 7 to execute the standard process without comparing the conditions. On the other hand, if there are settings for the message converting information, i and j are initialized to 0 (step S3).

Then, the message converting device 5 judges in each designation unit if a message that has occurred fulfills either condition prescribed for one message in the designation unit. If a plurality of conditions are defined for one message in the designation unit, the fulfillment of every condition is required. If no conditions prescribed for one message in any designation unit are fulfilled at all, the process is shifted from terminal a to the step S57 in FIG. 7. On the other hand, if it is judged that the message that has occurred fulfills all the conditions for one message in the designation unit, the message converting device 5 judges if a condition as to the time range the message occurred is defined for the fulfilled conditions (step S9).

If a condition as to the time range the message occurred is defined for the fulfilled conditions, the message converting device 5 judges if the time the message occurred is within the time range defined in the designation unit (step S11). If the time the message occurred is not within the time range defined in the designation unit, the process is shifted from terminal a to the step S57 in FIG. 7

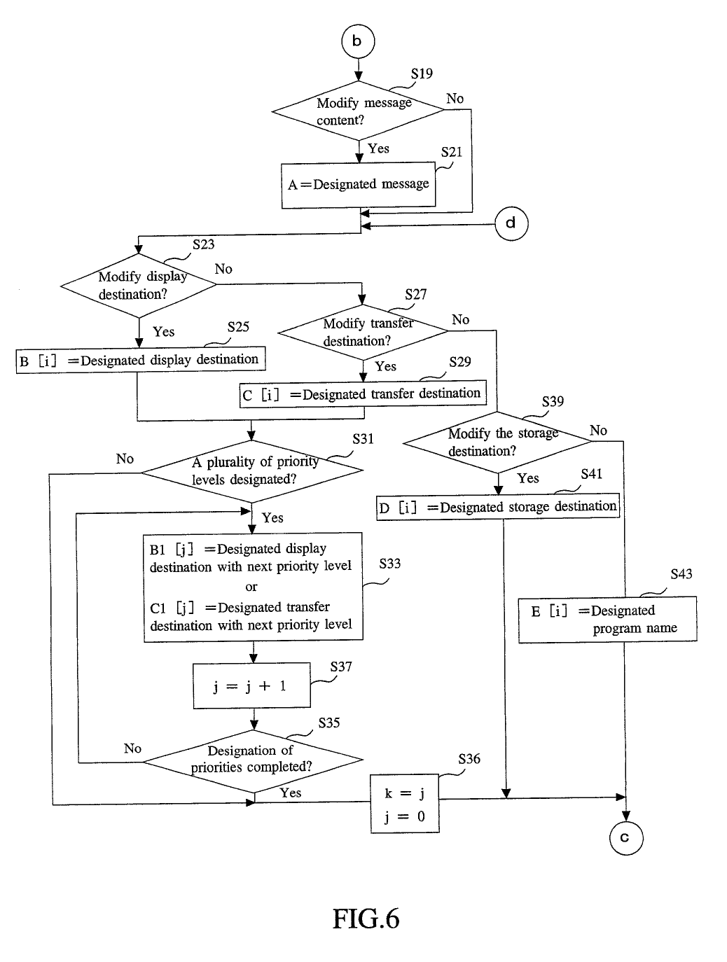

On the other hand, if the time the message occurred is within the time range defined for one message in the designation unit, the message converting device 5 judges if the designation unit includes conditions for a plurality of messages (step S13). If the designation unit of the condition doesn't include any combination of conditions for a plurality of messages, the process is shifted from terminal b to the step S19 in FIG. 6. If the designation unit of the condition comprises a combination of conditions for a plurality of messages, the message converting device 5 judges if every message included in the designation unit of the condition has occurred. If all of the messages haven't occurred, the present message occurrence is recorded (step S17), and the process is ended. If all of the messages have occurred, the process is shifted from terminal b to step S19 in FIG. 6

In step S19 in FIG. 6, the message converting device 5 judges by examining “Type of operation” if the modification of the message content is prescribed. If the modification of the message content is prescribed, the designated message content is stored as variable “A” (step S21). If the modification of the message content is not prescribed or after step S21 is processed, the message converting device 5 judges by examining “Type of operation” if the modification of the display destination (device) is defined. If the modification of the display destination is defined, the display device designated is stored in the array variable B[i] (step S25). If the modification of the display destination isn't defined, the message converting device 5 judges if the modification of the transfer destination is defined (step S27). If the modification of the transfer destination is defined, the designated transfer destination is stored in the array variable C[i] (step S29).

After processing step S25 and step S27, the message converting device 5 judges if a plurality of priority levels are designated (step S31). This process is for a case a plurality of transfer destinations and/or display destination defined, and the priority defined for each of those destinations. If a plurality of priority levels isn't designated, the process is shifted to the step S36. On the other hand, if a plurality of priority levels is defined, to modify the display destination, the display destination with the next priority level is stored in the array variable B1[j], and to modify the transfer destination, the transfer destination with the next priority level is stored in the array variable C1[j] (step S33). Next, j is incremented by 1 (step S37). Then, the message converting device 5 judges if the designation of the priority levels is completed (step S35). If there are still more priority levels to be processed, the process returns back to the step S33. If there are no more priority levels to be processed, the value of j is substituted for k, and the value of j is initialized to 0. Then, the process is shifted from terminal c to the step S45 in FIG. 7.

If the modification of the transfer destination is judged not to have been designated in step S27, the message converting device 5 judges by examining “Type of operation” if the modification of the storage destination is defined (step S39). If the modification of the storage destination is defined, the designated storage destination is stored in the array variable D[i] (step S41), and the process is shifted from terminal c to the step S45 in FIG. 7

If the modification of the storage destination is not defined, the program to be activated may be defined. Therefore, in such a case, the name of the designated program is stored in the array variable E[i] (step S43), and the process is shifted to the step S45.

In step S45 in FIG. 7, the message converting device 5 judges if the operation time is designated. If the operation time is designated, the message event with designated operation time is stored in another storage device (step S47). Here, the contents of the message event to be stored are the contents of the variable A, array variable B[i], c[i], d[i], and E[i] for i in step S47, the values of the variable k, and the contents of all of array variable B1 and C1 at the time of the step S47. In addition, the monitoring of the operation time is started (step S49). Then, i is decremented by 1. In this embodiment, only the processing contents which are immediately executed is stored in variable B, C, D, E, B1, and C1.

If it is judged that the operation time is not designated in step S45, or after Step S51 is processed, the message converting device 5 judges if there is any item in “Type of operation” left not processed. If there are items in “Type of operation” left unprocessed, i is incremented by 1, and process goes back to step S23.

On the other hand, if every designated item in “Type of operation” is processed, the message “A” is displayed on the display destination stored in B[i] (step S57). If the modification of the display destination is defined, the message is displayed on the designated display device. If the modification of the message content is defined, the modified message is displayed. The modification of the display destination and of the message content can be executed at the same time as well. If the display destination is not designated, no process is actually executed in step S57.

Next, the message “A” is transferred to the transfer destination stored in C[i] (step S59). If modification of the transfer destination is defined, the message is transferred to the designated transfer destination. If modification of the message content is defined, the modified message is transferred. The modification of the transfer destination and of the message content can be executed at the same time as well. If the transfer destination is not designated, no process is actually executed in step S59.

Next, the message “A” is recorded in the storage device stored in C[i] (step S61). If the modification of the storage device is defined, the message is recorded in the designated storage device. If the modification of the message content is defined, the modified message is recorded. The modification of the storage device and of the message content can be executed at the same time. If the storage device is not designated, no process will actually be executed in step 61.

Next, the program whose name is stored in E[i] will be activated (step S63). If the program to be activated is defined, the designated program will be activated. However, if the program to be activated is not designated, no process will actually be executed in step 63.

Next, the message converting device 5 judges if the process from step S57 to step S63 has succeeded. If successful, it is determined if i=0 (step S73). If i=0, all contents of the process defined have been executed, and the message processing is complete. On the other hand, if i is not zero, i is decremented by 1 (step S75), and the process goes back to step S57.

If the process from step S57 to step S63 has failed, it is determined whether j<k (step S67). If j<k, a plurality of priority levels are designated, and there are unexecuted operations at lower levels. This is because, if a plurality of priority levels are designated, k is more than 1 because of step 37 in FIG. 6, and j is initialized to 0 in Step S36 in FIG. 6. In addition, as j is to be incremented by 1 in step S71 as described below, then, j=k if processings for all of the priority levels are executed. If j<k is not the case, the process proceeds to step S73.

On the other hand, if j<k, the B1[j] is substituted for B[i], and C1[j] for C[i] (step S69). j is then incremented by 1 (step S71), the process goes back to Step S57 and the process from step S57 to step S63 is executed. To execute the process according to the order of priority levels, j is incremented from j=0.

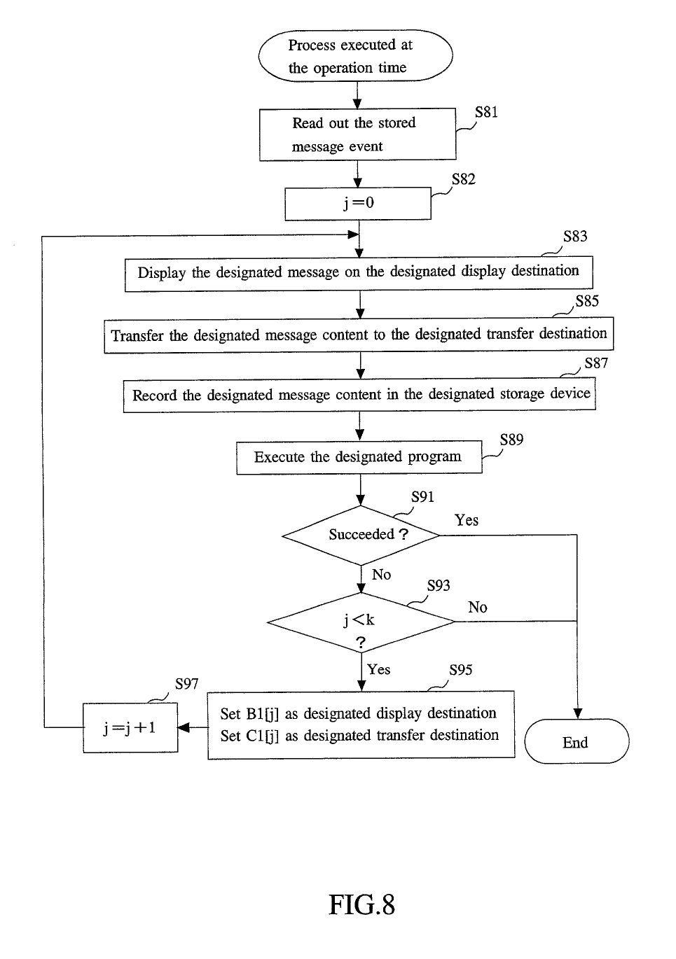

The following is a description of the process executed at the operation time prescribed in “Content of operation” using FIG. 8. If the operation time comes, the message event stored is read out (step S81). As described above, the contents of the message event stored are the contents of the variable A, the contents of the C[i], C[i], D[i], and E[i] for i at step S47, variable k, and all of the contents of B1 and C1 at the time of step S47. These are read out. Next, j is initialized to 0 (step S82).

Next, the designated message content (the contents of A) is displayed on the display destination (the contents of B[i]) (step S83). Also, the designated message content (the contents of A) is transferred to the designated transfer destination (the contents of C[i]) (step S85). Also, the designated message content (the contents of A) is recorded in the designated storage device (the contents of D[i]) (step S87). Next, the designated program (the contents of E[i]) will be activated (step S89). Not all the steps from step S83 to S89 are to be executed, only the steps that includes the designation are executed.

Next, the message converting device 5 judges if the process from step S57 to step S63 has succeeded. If successful, the process is complete. On the other hand, if this is not the case, it is determined whether j<k (step S93). As described above (as to step S67), this is to judge whether a plurality of priority levels are defined, and if defined, to judge whether processings for all the priority levels are executed. If j<k, B1[j] is set for the designated display device, C1[j] is set for the designated transfer destination. Then, j is incremented by 1 (step S97), and the process goes back to step S83. Next, the steps from step S83 to S89 are executed again.

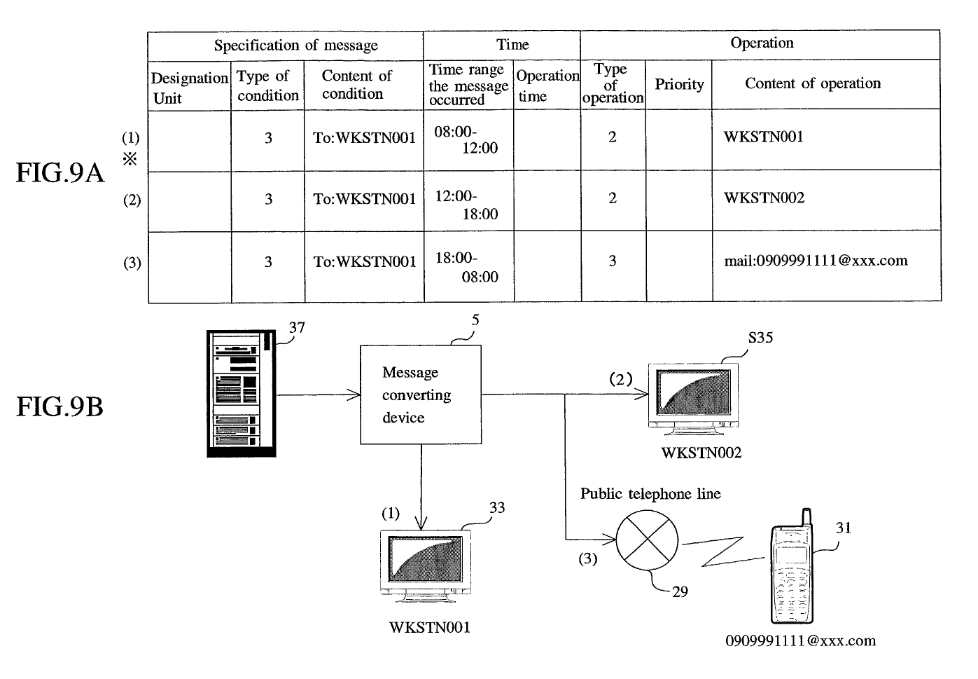

The execution of the process by the message converting device 5 as described above enables various processing to be carried out. For example, suppose that the message converting information as described in FIG.9A is set. In designation unit (1), “1” is designated for “Type of condition”, “To:WKSTN001” for “Content of condition”, “08:00-12:00” for “Time range the message occurred”, “2” for “Type of operation”, “WKSTN001” for “Content of operation”. If designation unit (1) is set for the standard sending destination, it is not necessary to be included in the message converting information. In designation unit (2), “1” is designated for “Type of condition”, “To:WKSTN00” for “Content of condition”, “12:00-18:00” for “Time range the message occurred”, “2” for “Type of operation”, “WKSTN002” for “Content of operation”. In designation unit (3), “3” is designated for “Type of condition”, “To:WKSTN001” for “Content of condition”, “18:00-08:00” for “Time range the message occurred”, “3” for “Type of operation”, “mail:0909991111@xxx.com” for “Content of operation”.

If such message converting information is defined, the message to the display device WKSTN001 (33) occurring at Computer 37 is sent to the message converting device 5 as shown in FIG. 9B. If the time the message occurs is within“08:00-12:00” as defined in the designation unit (1), the message converting device sends the message to the standard display device WKSTN001 (33). The display device WKSTN001 (33) is, for example, a console placed in the computer room. On the other hand, if the time the message occurs is within“12:00-18:00” as defined in the designation unit (2), the message converting device 5 sends the message to the designated display device WKSTN002 (35). The display device WKSTN002 (35) is, for example, a console placed in other office. If the time the message occurs is within“18:00-08:00” as defined in the designation unit (3), the message converting device 5 will convert the message into e-mail form and send it to the e-mail server of the cellular phone 31 with the-mail address 0909991111@xxx.com. After this, the e-mail including the message is sent to cellular phone 31 via public telephone line 29. Therefore, the display device or transfer destination can be flexibly set according to the time range of the message that occurred.

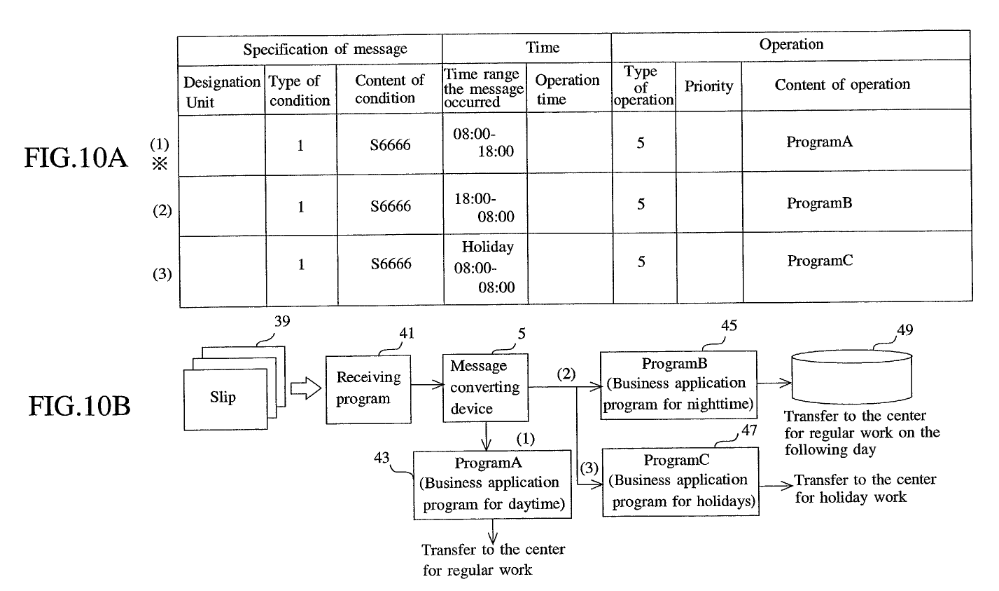

Next, suppose that the message converting information as described in FIG. 10A is defined. In designation unit (1), “1” is designated for “Type of condition”, “S6666” for “Content of condition”, “08:00-18:00” for “Time range the message occurred”, “5” for “Type of operation”, “ProgramA” for “Content of operation”. If designation unit (1) is defined for the standard program to be activated, it is not necessary to be included in the message converting information. In designation unit (2), “1” is designated for “Type of condition”, “S6666” for “Content of condition”, “18:00-08:00” for “Time range the message occurred”, “5” for “Type of operation”, “ProgramB” for “Content of operation”. In designation unit (3), “1” is designated for “Type of condition”, “S6666” for “Content of condition”, “18:00-08:00” for “Time range the message occurred”, “5” for “Type of operation”, “ProgramB” for “Content of operation”.

With the message converting information defined as shown above, if information, for example, slip 39 is input into a receiving program 41, the receiving program 41 sends the message with message number “S6666” to the message converting device 5 as shown in FIG. 10B. If the time the message occurs is within “08:00-18:00” as defined in the designation unit (1), the message converting device 5 will activate ProgramA 43, which is the business application program for daytime. The result of the execution of ProgramA 43 is forwarded to the center for the regular work.

On the other hand, If the time the message occurs is within “18:00-08:00” as defined in the designation unit (2), the message converting device 5 will activate ProgramB 45, which is the business application program for nighttime. The result of the execution of ProgramB 45 is stored in the storage device 49 to be transferred to the center for the regular work on the following day. If the time the message occurs is within “holiday 08:00-08:00” as defined in the designation unit (3), the message converting device 5 will activate ProgramC 47, which is the business application program for holiday. The result of the execution of ProgramC 47 is forwarded to the center for the holiday work.

Therefore, the program to be activated can be flexibly modified according to the time range the message occurs.

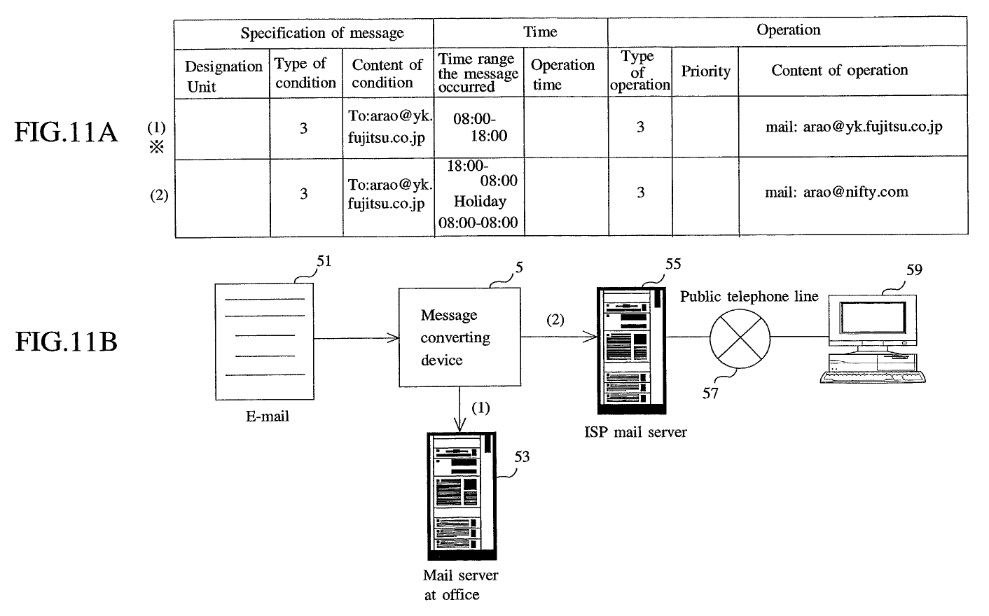

Also, suppose that message converting information as described in FIG. 11A is defined. In designation unit (1), “3” is designated for “Type of condition”, “To:arao@yk.fujitsu.co,jp” for “Content of condition” , “08:00-18:00” for “Time range the message occurred”, “3” for “Type of operation”, “mail:arao@yk.fujitsu.co.jp” for “Content of operation”. If designation unit (1) is defined for the standard transfer destination, it is not necessary to be included in the message converting information. In designation unit (2), “3” is designated for “Type of condition”, “To:arao@yk.fujitsu.co,jp” for “Content of condition”, “holiday 08:00-08:00” for “Time range the message occurred”, “3” for “Type of operation”, “mail:arao@nifty.com” for “Content of operation”.

With the message converting information defined as shown above, the message converting device 5 receives the e-mail 51 with the e-mail address “arao@yk.fujitsu.co.jp” once, and if the time the e-mail 51 occurred is within “08:00-18:00” defined in the designation unit (1), the e-mail 51 is transferred to the mailbox for “arao@yk.fujitsu.co.jp” in the mail server 53 of the office. The destination user receives the e-mail 51 from the mail server 53. On the other hand, if the time the message occurs is within “18:00-08:00” as defined in the designation unit (2), the e-mail 51 is transferred to the-mailbox for “arao@nifty.com” in the Internet Service Provider (ISP) mail server 55 of the ISP that is under contract with the destination user. The destination user will receive the e-mail 51 from the ISP mail server 55 via a public telephone line 57 to the computer 59, etc. located at the user's home. Therefore, the e-mail is transferred in a time range while the user is not at the office, and the user can read the e-mail while staying home.

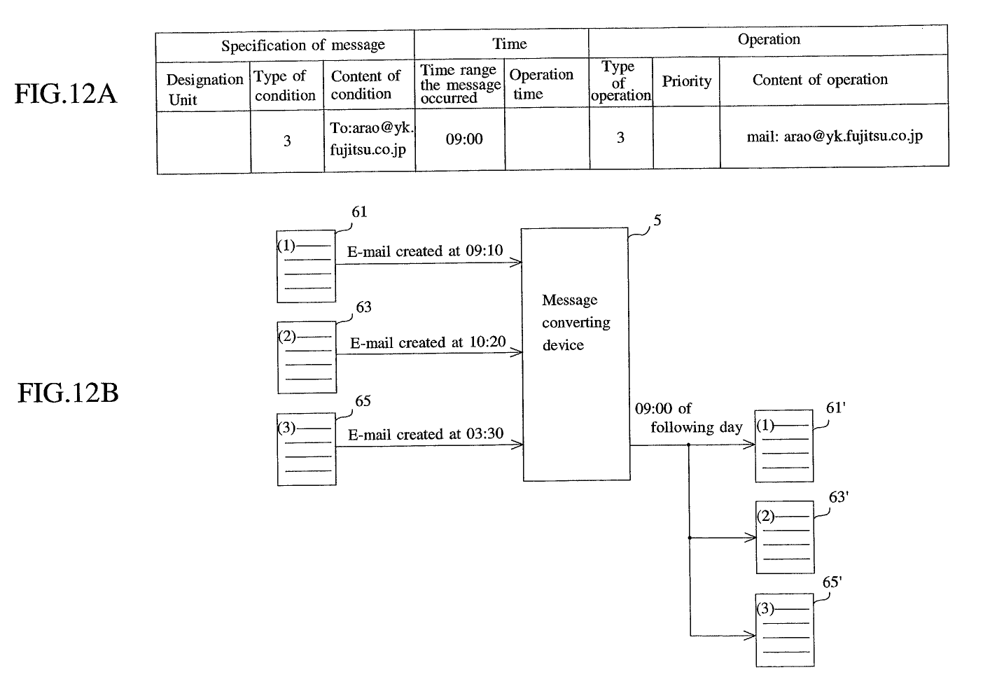

Further, suppose that message converting information as described in FIG. 12A is defined. In the message converting information, “3” is designated for “Type of condition”, “To:arao@yk.fujitsu.co.jp” for “Content of condition”, “09:00” for “Time of operation”, “3” for “Type of operation”, “mail:arao@yk.fujitsu.com” for “Content of operation”.

With the message converting information defined as shown above, for example, an e-mail 61 occurring at 09:10, an e-mail 63 occurring at 10:20, an e-mail 65 occurring at 03:30, all with the designated destination “arao@yk.fujitsu.jp”, are stored in the message converting device 5 once. These e-mails are then transferred to the designated e-mail address “arao@yk.fujitsu.com” at 09:00on the following day as shown in FIG. 12B.

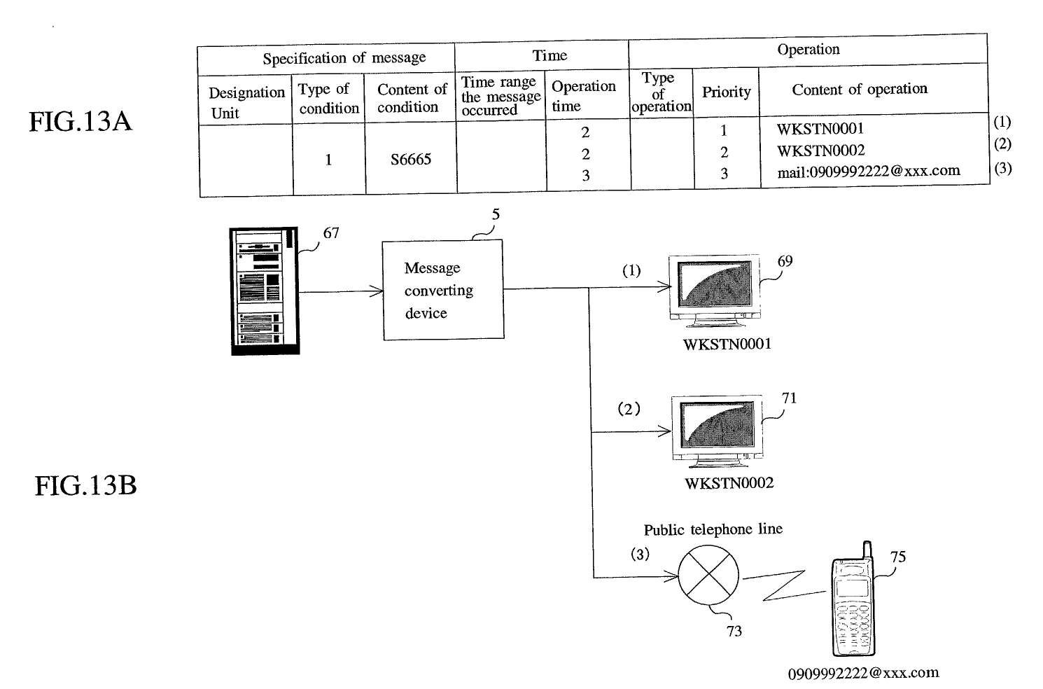

Further, suppose that the message converting information shown in FIG. 13A is defined. In the message converting information, “1” is designated for “Type of condition”, “S6665” for “Content of condition”, and for the first item, “2” for “Type of operation” and “1” for “Priority” and “WKSTN00001” for “Content of operation”, and for the second item, “2” for “Type of operation” and “2” for “Priority” and “WKSTN00002” for “Content of operation”, and as for the third item, “3” for “Type of operation” and “3” for priority and “mail:0909992222@xxx.com” for “Content of operation”.

With the message converting information defined as shown above, for example, when the message with the message number “S6665” occurs at the computer 67, the message is sent to the message converting device 5 described in FIG. 13B. The message converting device 5 sends the message to the display device “WKSTN0001” (69) and causes the display device to display the message. However, there may be cases where the message cannot be displayed for various reasons such as, for example, the display device “WKSTN0001” (69) being turned off. In this case, the message converting device 5 sends the message to the display device “WKSTN0002” (71) and causes the display device to display the message. For the same reason as above, there may be a case where the display device “WKSTN0002” (71) cannot display the message. When the display device “WKSTN0002” (71) cannot display the message, the message converting device 5 will convert the message into e-mail form and sends it to the mail server where the mailbox with the e-mail address 0909991111@xxx.com is installed. The e-mail is transferred from mail server, for example, to a cellular phone 75 via a public telephone line 73. Therefore, the message can be transferred to the person who is more capable of dealing with the message more rapidly. As the cost of communication with a cellular phone is high and the capacity of data transfer is limited, the cellular phone can be set as the destination if no other destinations are available.

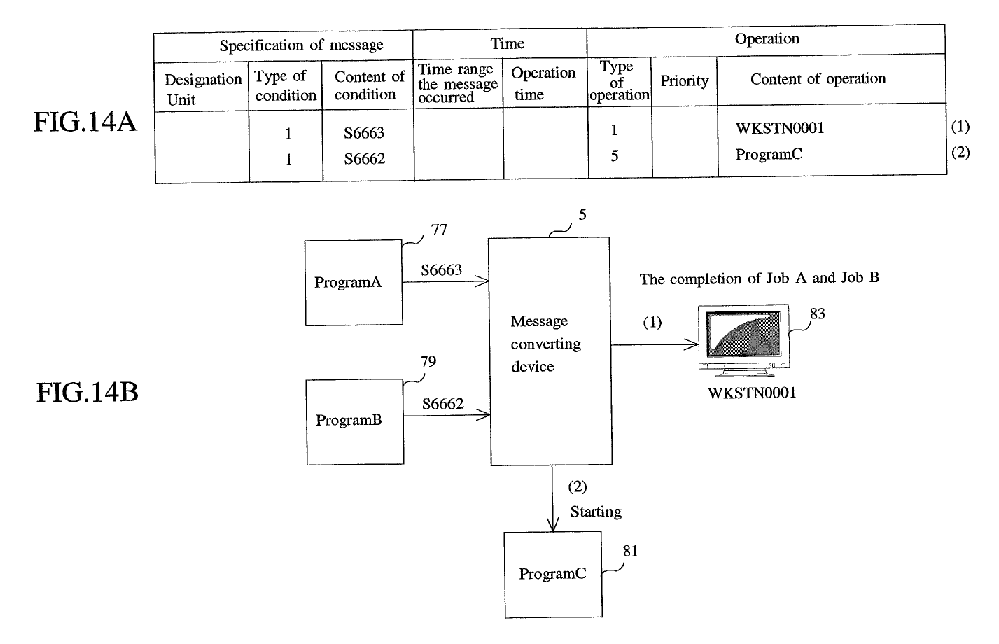

Further, suppose that the message converting information described in FIG. 14A is defined. In the message converting information, “1” is designated for the first “Type of condition” and “S6663” for “Content of operation”, and “1” is designated for the second of “Type of condition” and “S6662” for “Content of condition”, and “2” is designated for the first “Type of operation” and “WKSTN0001” for “Content of operation”, and “5” is designated for the second “Type of operation” and “ProgramC” for “Content of operation”. This means that the conditions for a combination of two messages are defined.

With the message converting information defined as shown above, for example, if ProgramA 77 creates a message with the message number “S6663” and ProgramB 79 creates a message with the message number “S6662” as well, those messages are sent to the message converting device 5, and the message converting device 5 informs the display device WKSTN0001 (83) of the completion of JobA by ProgramA and the completion of JobB by ProgramB according to “2” in “Type of operation”. In addition to this, ProgramC (81) will be activated according to “5” in “Type of operation”. Therefore, various processing can be executed based on condition for the occurrence of a plurality of messages.

The processes described as for the drawings from FIG. 9 to FIG. 14 are just given as an example. By setting the message converting information, various processing, including the combination of the processes described above, can be executed by the message converting device 5.

Next, setting of message converting information utilizing the message converting information setting unit 9 is described. The message converting information setting unit 9 as shown in FIG. 1 receives e-mail 15 or a control message from the computer 17, and stores the message converting information in the message converting information storage unit 7. At the computer 17, for example, a program to output the control message including the message converting information is executed. For example, just before computer 17 is turned off, a control message including the message converting information for setting the condition after computer 17 is turned off may occur. It is also possible to have a configuration where, if a prescribed operation is executed, for example, if a prescribed button of computer 17 is pushed, the program described above may send a control message including the message converting information to the control converting information setting unit 9.

Here, a description is given for the case of sending message converting information to the message converting information setting unit 9 by using e-mail 15. FIG. 15 is an example of the format that the header part of e-mail 15 includes the message converting information. For example, set X-cmsgstart to describe the start of the entire control message, set X-msgstart to describe the start of one control message, designate “Type of condition” by X-ck, “Content of condition” by X-contc, “Time range the message occurred” by X-time1, “Operation time” by X-time2, “Type of operation” by X-ok, Priority by “X-prio”, “Content of operation” by X-conto, set X-msgend to describe the end of one control message, and set X-csmgstop to describe the end of entire control message. By repetition of the one control message from its start to its end, a plurality of control message can be defined.

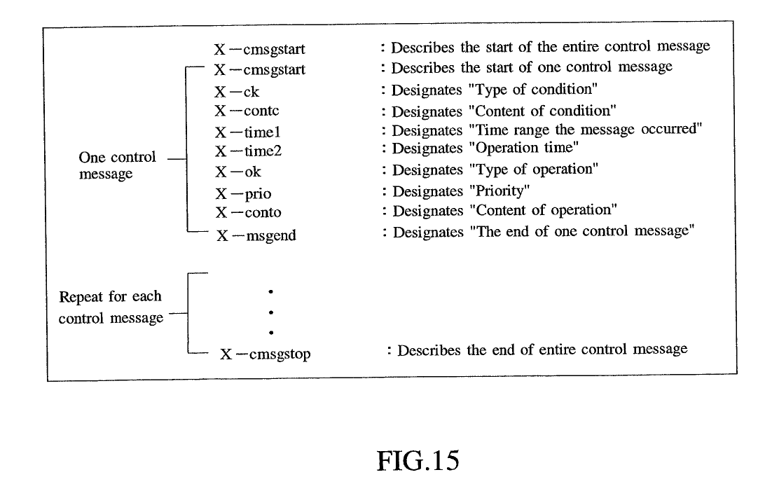

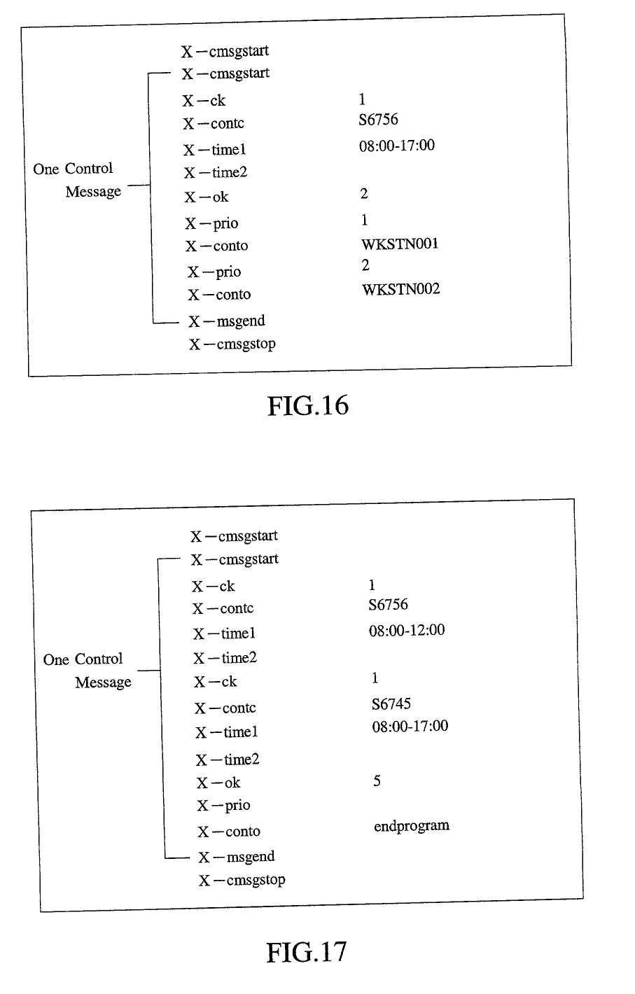

An example of mail header set according to designation unit (1) is shown in FIG. 16. The only difference is the tag form described in Table 2. Also, an example of mail header set according to designation unit (5) is shown in FIG. 17. The only difference is the tag form described in Table 3.

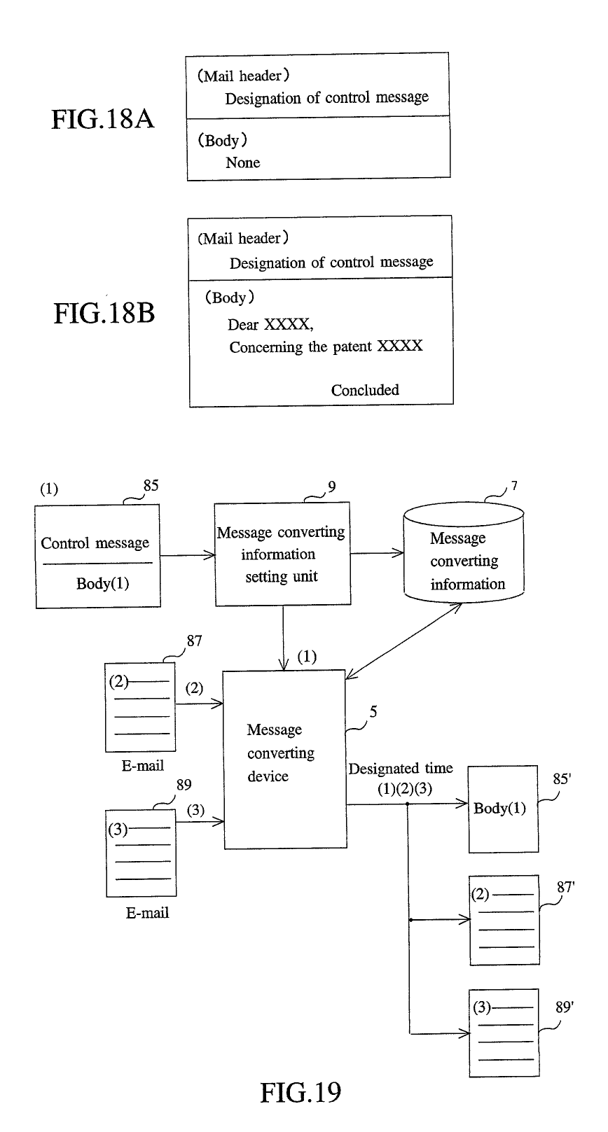

In this configuration, a control message is included in the header part of the e-mail 15, so that the e-mail 15 can be composed in such a manner that a control message is included in the header part and with nothing in the body as shown in FIG. 18A. This is a form used for the case if it is necessary to set only the message converting information. A message sent after the message converting information is set by the e-mail 15 is processed according to the message converting information included in the control message. By using e-mail, the message converting information can be set easily at anytime, at any location.

Also, as shown in FIG.18B, the e-mail can be composed in a form where the control message is included in the header part and sentences in the body as is usually the case with normal mail. The message converting information can be set while sending e-mail as usual. The message with the control message in the header part and messages sent after the e-mail including the control message in its header part sent are processed according to the message converting information included in the control message.

The message converting information setting unit 9 examines the header part of the e-mail. If it finds X-cmsgstart, it will cut out the part from X-cmsgstart to X-cmsgstop and stores it as the message converting information into the message converting information storage unit 7. Also, it is possible that the examination of the header part of e-mail is executed if there's indication included in the title (Subject) of e-mail as to the message converting information. Further, a configuration is also possible where if there is no text body in the e-mail as shown in FIG. 18A, an e-mail is sent to the address set at the message converting information setting unit 9.

For example, as shown in FIG. 19, if the message converting information setting unit 9 receives an e-mail 85 including a control message in its header, the message converting information setting unit 9 stores message converting information included in the control message into the message converting information storage unit 7. If this message converting information is to transfer e-mails sent by an appointed time to a predetermined address at an designated time, e-mails 87 to 89, are stored temporarily by the message converting device 5 together with the e-mail 85. Then, at the designated time, the message converting device 5 sends e-mails 85′, 87′, and 89′ to the predetermined address.

If a large number of e-mails are sent, setting the conditions for each e-mail every time is very troublesome. This embodiment shown here makes it possible to set conditions for a multiplicity of e-mails quite easily at one time.

The configuration described here is that a control message is included in the header part of an e-mail. However, the body of the e-mail may also include similar data such as, for example, the data format described in Table 1.

The present invention is by no means limited to the above embodiments, and various modifications are possible. For example, the message is described as including messages displayed on the display device, messages exchanged among programs, and communication messages such as e-mail. However, limits can be set for the application of the embodiments as to the meaning of the message.

Further, System 1 and the message converting device 5 are depicted separately in FIG. 1, however, the message converting device 5 can be installed as a program executed in System 1. The message converting information storage unit 7 can be implemented in System 1 as well.

If the message converting device 5 is implemented as a program, the program can be stored in storage media or storage devices such as hard disc, magnet optical disk, CD-ROM, DVD-ROM, etc. Depending on a situation, the program can also be distributed via a transmission line of a network.

Also, as described above, a configuration where the message converting information setting unit 9 is included in the message converting device 5 is also possible. The processing flowchart described in the drawings from FIG. 5 to FIG. 8 is merely provided as an example, and other flowcharts with similar function can also be adopted.

According to the present invention, technology to modify or set processing content for a message according to the time the message occurred, etc. can be provided .

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A message processing system comprising:
judging means for analyzing a received message, and for judging whether a predetermined condition including a requirement relating to a time when said received message occurs is fulfilled; and
means for performing a process corresponding to the fulfilled predetermined condition if said judging means judged that said received message fulfilled said predetermined condition.

2. The message processing system set forth in claim 1, further comprising:
a storage device for storing said predetermined condition and a processing content corresponding to said predetermined condition; and
setting means for setting said predetermined condition and a processing content corresponding to said predetermined condition into said storage device.

3. The message processing system set forth in claim 1, wherein said process corresponding to said predetermined condition is at least one of modification or setting of contents of said received message, modification or setting of display destination of said received message, modification or setting of transmission destination of said received message, modification or setting of recording destination of said received message, and execution of a program in correspondence with said received message.

4. The message processing system set forth in claim 1, wherein said process corresponding to said predetermined condition is a process for changing notification destination of said received message in accordance with a priority set in advance.

5. The message processing system set forth in claim 1, wherein said process corresponding to said predetermined condition is a process for executing a processing content corresponding to said predetermined condition at a time corresponding to said predetermined condition.

6. The message processing system set forth in claim 1, wherein said predetermined condition includes a requirement relating to a combination of a plurality of messages.

7. The message processing system set forth in claim 2, wherein said setting means receives an e-mail including a predetermined condition, a processing content corresponding to said predetermined condition, and a mail body, and sets said predetermined condition and said processing content corresponding to said predetermined condition into said storage device, and wherein said judging means determines whether a message subsequent to said e-mail fulfills said predetermined condition set by said setting means in response to receipt of said e-mail.

8. A storage medium for storing a message processing program, said message processing program comprising the steps of:
analyzing a received message, and judging whether a predetermined condition including a requirement relating to a time when said received message occurred is fulfilled; and
performing a process corresponding to the fulfilled predetermined condition if it is judged in said step of analyzing and judging that said received message fulfilled said predetermined condition.

9. The storage medium set forth in claim 8, said program further comprising a step of:
setting said predetermined condition and a processing content corresponding to said predetermined condition into a storage device.

10. The storage medium set forth in claim 8, wherein said performing step comprises at least one step of:
modifying or setting contents of said received message;
modifying or setting display destination of said received message;
modifying or setting transmission destination of said received message;
modifying or setting recording destination of said received message; and
executing a program in correspondence with said received message.

11. The storage medium set forth in claim 8, wherein said performing step comprises a step of changing notification destination of said received message in accordance with a priority set in advance.

12. The storage medium set forth in claim 8, wherein said performing step comprises a step of executing a processing content corresponding to said predetermined condition at a time corresponding to said predetermined condition.

13. The storage medium set forth in claim 9, wherein said setting step comprises the steps of:
receiving an e-mail including a predetermined condition, a processing content corresponding to said predetermined condition, and a mail body; and
setting said predetermined condition and said processing content corresponding to said predetermined condition into said storage device,
and wherein said analyzing and judging step comprises a step of, in response to receipt of said e-mail, determining whether a message subsequent to said e-mail fulfills said predetermined condition set in said setting step.

14. A message processing method comprising the steps of:
analyzing a received message, and judging whether a predetermined condition including a requirement relating to a time when said received message occurred is fulfilled; and
performing a process corresponding to the fulfilled predetermined condition if it is judged in said step of analyzing and judging that said received message fulfilled said predetermined condition.

15. The message processing method set forth in claim 14, further comprising a step of:
setting said predetermined condition and a processing content corresponding to said predetermined condition into a storage device.

16. The message processing method set forth in claim 14, wherein said performing step comprises at least one step of:
modifying or setting contents of said received message;
modifying or setting display destination of said received message;
modifying or setting transmission destination of said received message;
modifying or setting recording destination of said received message; and
executing a program in correspondence with said received message.

17. The message processing method set forth in claim 14, wherein said performing step comprises a step of changing notification destination of said received message in accordance with a priority set in advance.

18. The message processing method set forth in claim 14, wherein said performing step comprises a step of executing a processing content corresponding to said predetermined condition at a time corresponding to said predetermined condition.

19. The message processing method set forth in claim 15, wherein said setting step comprises the steps of:
receiving an e-mail including a predetermined condition, a processing content corresponding to said predetermined condition, and a mail body; and
setting said predetermined condition and said processing content corresponding to said predetermined condition into said storage device,
and wherein said analyzing and judging step comprises a step of, in response to receipt of said e-mail, determining whether a message subsequent to said e-mail fulfills said predetermined condition set in said setting step.
